(19) United States
(12) Patent Application Publication
(10) Pub. No.: US 2012/0236589 A1
(43) Pub. Date: Sep. 20, 2012

(54) BACKLIGHT AND DISPLAY

(75) Inventor: Tsuyoshi Hasegawa, Daito City (JP)

(73) Assignee: SANYO ELECTRIC CO., LTD., Osaka (JP)

(21) Appl. No.: 13/401,453

(22) Filed: Feb. 21, 2012

(30) Foreign Application Priority Data
Mar. 15, 2011 (JP) 2011-057037

(51) Int. Cl. G09F 13/04

(52) U.S. Cl. 362/602

(57) ABSTRACT

A backlight is provided with a light guide plate, a light source having a plurality of light emitting elements which are arranged to face a side surface of the light guide plate, and an elastic guide part which extends in a direction along which the light emitting elements are arranged, which is joined to the light source and to a light entrance part of the light guide plate through which light from the light source enters the light guide plate, and which reflects light emitted from the light source to direct the light to a side surface of the light guide plate.

### BACKGROUND OF THE INVENTION

This application is based on Japanese Patent Application No. 2011-057037 filed on Mar. 15, 2011, the contents of which are hereby incorporated by reference.

1. Field of the Invention

The present invention is related to a back light and a display device.

2. Description of the Related Art

There has conventionally existed a so-called side-edge type liquid crystal display (LCD; Liquid Crystal Display), which uses a backlight configured such that an LED (Light Emitting Diode) is disposed as a light source on a side surface of a light guide plate.

In a side-edge type liquid crystal display, for the purpose of obtaining higher brightness with fewer LEDs, a large amount of current is supplied to the LEDs. As a result, heat is generated concentratedly at some parts around a side surface of a light guide plate, and in some cases, the heat may cause the light guide plate to warp.

Here, FIG. 4 is a schematic perspective view showing an example of a configuration of a conventional backlight used in a side-edge type liquid crystal display. The conventional backlight shown in FIG. 4 is provided with heat dissipation plates 1, LED light sources 2, a metal plate 3, a reflection sheet 4, a light guide plate 5, a diffusion sheet 6, a prism sheet 7, and a diffusion sheet 8.

The heat dissipation plates 1, which extend right and left and are substantially L-shaped in side view, are respectively fitted to upper and lower edge parts of the metal plate 3 so as to face each other. The LED light sources 2 each include a substrate that extends in a strip-shape and a plurality of LEDs (light emitting elements) arranged on the substrate. The substrate of the LED light sources 2 are fitted to opposing surfaces of the heat dissipation plates 1. The reflection sheet 4 is disposed on the metal plate 3. At a front surface side of the reflection sheet 4, the light guide plate 5 is disposed. The plurality of LEDs arranged in the LED light sources 2 face upper or lower side surface of the light guide plate 5. And the diffusion sheet 6 is disposed at a front surface side of the light guide plate 5, the prism sheet 7 is disposed at a front surface side of the diffusion sheet 6, and the diffusion sheet 8 is disposed at a front surface side of the prism sheet 7.

Light from the LED light sources 2 which enters the light guide plate 5 through the upper and lower side surfaces thereof is taken out of the light guide plate 5 through the front surface thereof as surface light. The light taken out from the light guide plate 5 through the front surface thereof is diffused by passing through the diffusion sheet 6, collected by passing through the prism sheet 7, diffused again by passing through the diffusion sheet 6, and then illuminates a back surface of a liquid crystal panel (not shown) (a display section).

FIG. 6A is a schematic side sectional view showing the conventional backlight in a normal condition in which the light guide plate 5 is not warped (note that FIG. 6A, and later-referred-to FIGS. 6B and 6C only show an upper LED light source 2 disposed at the upper side, and a lower LED light source 2 disposed at the lower side is not shown).

In the normal condition, in which the light guide plate 5 is not warped, light emitted from the LED light source 2 enters the light guide plate 5 through a side surface of the light guide plate 5 in a correct manner. A portion of the light is reflected on a dot pattern (not shown) formed on a back surface (in FIG. 6A, a lower surface) of the light guide plate 5 to be taken out of the light guide plate 5 via the front surface thereof, another portion of the incident light is taken out of the light guide plate 5 via the back surface thereof to be reflected on the reflection sheet 4 to be taken out of the light guide plate 5 through the front surface thereof. At this time, emission brightness of the backlight is substantially uniform, and thus the distribution of brightness on the liquid crystal panel is also substantially uniform.

However, if heat generated in the LED light source 2 is concentrated on upper and lower edge parts of the light guide plate 5, it may cause the light guide plate 5 to warp. FIG. 5 is a diagram showing the conventional backlight as seen from above, in a condition where the light guide plate 5 is warped. As shown in FIG. 5, an edge part of the light guide plate 5 curves in a right-left direction like waves. FIG. 6B is a schematic side sectional view taken along line A-A (see FIG. 5) where the edge part of the light guide plate 5 is curved convex toward the front. As shown in FIG. 6B, a portion of light emitted from the LED light source 2 is not incident on the side surface of the light guide plate 5 in a correct manner; such a portion of light is reflected on the reflection sheet 4 after being reflected on the back surface of the light guide plate 5, or directly reflected on the reflection sheet 4.

FIG. 6C is a schematic side sectional view taken along line B-B (see FIG. 5) where the edge part of the light guide plate 5 is curved backward. As shown in FIG. 6C, a portion of light emitted from the LED light source 2 is not incident on the side surface of the light guide plate 5 in a correct manner; such a portion of light is diffused by the diffusion sheet 6 after being reflected on a front surface of the light guide plate 5.

### SUMMARY OF THE INVENTION

According to an aspect of the present invention, a backlight includes: a light guide plate; a light source having a plurality of light emitting elements which are arranged to face a side surface of the light guide plate; and an elastic guide part which extends in a direction along which the light emitting elements are arranged, which is joined to the light source and to a light entrance part of the light guide plate through which light from the light source enters the light guide plate, and which reflects light emitted from the light source to direct the light to a side surface of the light guide plate.

According to another aspect of the present invention, a display includes the above-configured backlight and a display section which is illuminated by the backlight.

### DESCRIPTION OF THE DRAWINGS

FIG. 1 is a schematic perspective view showing a backlight according to a first embodiment of the present invention.

FIG. 2A is a schematic side sectional view showing the backlight according to the first embodiment of the present invention in a normal condition.

FIG. 2B is a schematic side sectional view, taken along line A-A, showing the backlight according to the first embodiment of the present invention in a case in which a light guide plate is warped.

FIG. 2C is a schematic side sectional view, taken along line B-B, showing the backlight according to the first embodiment of the present invention in a case in which the light guide plate is warped.

FIG. 3A is a schematic side sectional view showing a backlight according to a second embodiment of the present invention in a normal condition.

FIG. 3B is a schematic side sectional view taken along line A-A, showing the backlight according to the second embodiment of the present invention in a case in which a light guide plate is warped.

FIG. 3C is a schematic side sectional view taken along line B-B, showing the backlight according to the second embodiment of the present invention in a case in which the light guide plate is warped.

FIG. 4 is a schematic perspective view showing an example of a conventional backlight.

FIG. 5 is a diagram showing the conventional backlight, as seen from above, in a condition where a light guide plate is warped.

FIG. 6A is a schematic side sectional view showing the conventional backlight in the normal condition.

FIG. 6B is a schematic side sectional view taken along line A-A, showing the conventional backlight in a case in which the light guide plate is warped.

FIG. 6C is a schematic side sectional view taken along line B-B, showing the conventional backlight in a case in which the light guide plate is warped.

### DESCRIPTION OF THE PREFERRED EMBODIMENTS

Hereinafter, an embodiment of the present invention will be described with reference to the accompanying drawings. A backlight embodying the present invention is incorporated in a liquid crystal display.

### First Embodiment

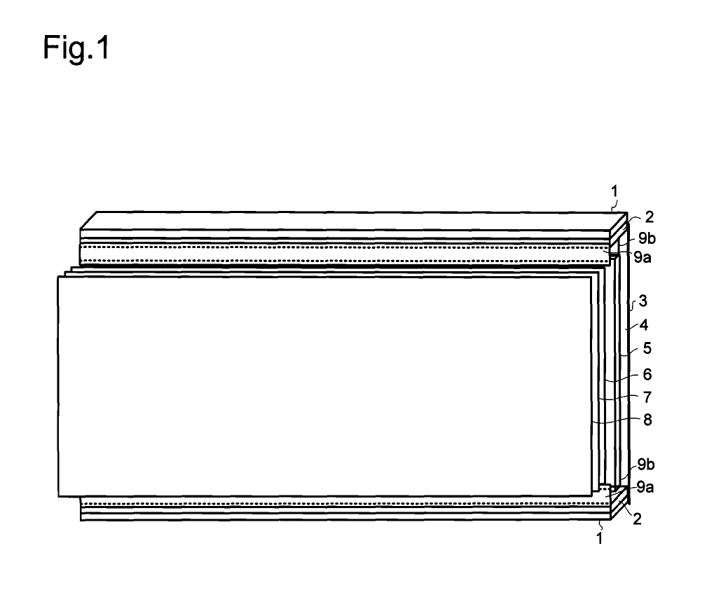

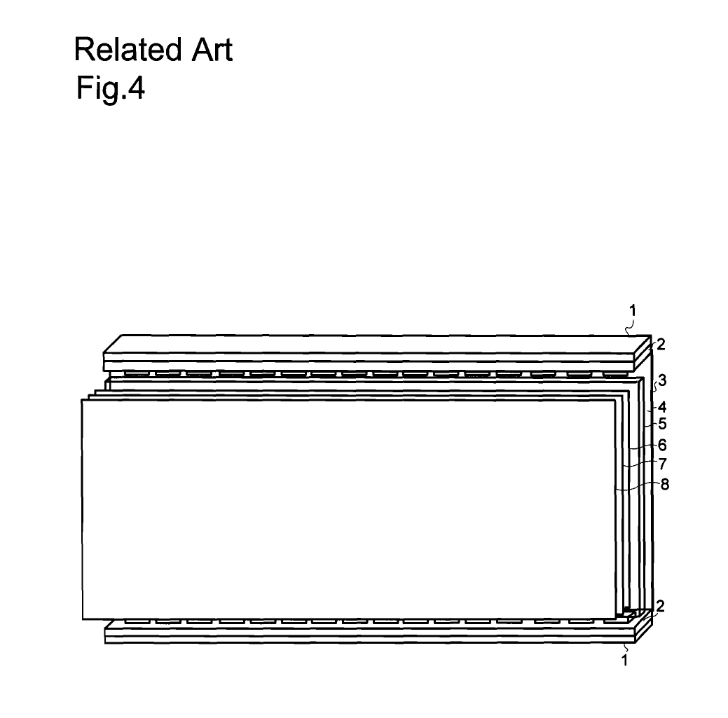

FIG. 1 is a schematic perspective view showing a backlight according to a first embodiment of the present invention. The backlight shown in FIG. 1 has basically the same configuration as the backlight shown in FIG. 4 already referred to above, but the main feature of the backlight shown in FIG. 1 is that it is provided with guide members 9a, 9b.

The guide members 9a, 9b are each an elastic diffusion-reflection sheet extending right and left (that is, in a direction in which plurality of LEDs are arranged in LED light sources 2). The guide members 9a, 9b can be produced, for example, by applying reflective coating to one surface of a diffusion sheet which is thinner than typical diffusion sheets used in backlights.

An edge part of the guide member 9a is fixed to a front-facing side surface of a substrate of an upper LED light source 2 with, for example, a double-faced tape. Another edge part of the guide member 9a is fixed to a front surface of an upper edge part (a light entrance portion through which light from the LED light source 2 enters the light guide plate 5) of the light guide plate 5 with, for example, a double-faced tape. An edge part of the guide member 9b is fixed to a back-facing side surface of the substrate of the upper LED light source 2 with, for example, a double-faced tape. Another edge part of the guide member 9b is fixed to a back surface of the upper edge part of the light guide plate 5 with, for example, a double-faced tape. In this way, front and back sides of LEDs in the upper LED light source 2 are covered with the guide members 9a, 9b.

Likewise, an edge part of the guide member 9a is fixed to a front-facing side surface of a substrate of a lower LED light source 2 with, for example, a double-faced tape. Another edge part of the guide member 9a is fixed to a front surface of a lower edge part (a light entrance part) of the light guide plate 5 with, for example, a double-faced tape. An edge part of the guide member 9b is fixed to a back-facing side surface of the substrate of the lower LED light source 2 with, for example, a double-faced tape. Another edge part of the guide member 9b is fixed to a back surface of the lower edge part of the light guide plate 5 with, for example, a double-faced tape. In this way, front and back sides of LEDs in the lower LED light source 2 are covered with the guide members 9a, 9b.

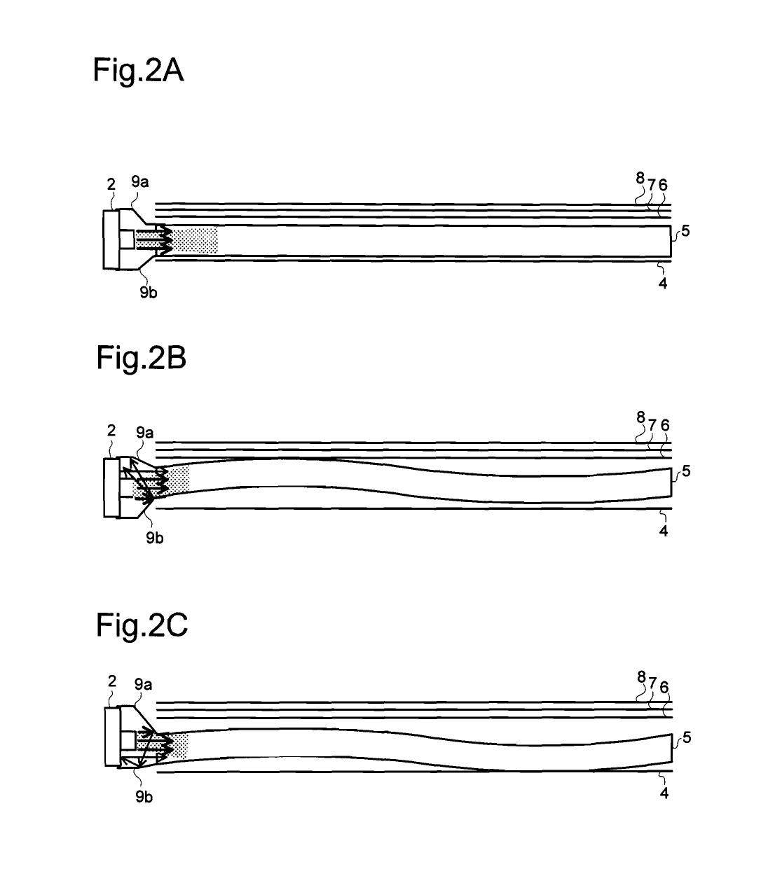

FIG. 2A is a schematic side sectional view showing the backlight according to the first embodiment of the present invention in a normal condition, in which the light guide plate 5 is not warped (note that FIG. 2A, and later-referred-to FIGS. 2B and 2C only show the upper LED light source 2, and the lower LED light source 2 is not shown).

In the normal condition, in which the light guide plate 5 is not warped, light emitted from the LED light source 2 enters the light guide plate 5 through a side surface of the light guide plate 5 in a correct manner. A portion of the light is reflected on a dot pattern (not shown) formed on a back surface (in FIG. 2A, a lower surface) of the light guide plate 5 to be taken out of the light guide plate 5 through the front surface thereof, another portion of the light is taken out of the light guide plate 5 through the back surface thereof to be reflected on the reflection sheet 4 to be taken out through the front surface of the light guide plate 5. At this time, emission brightness of the backlight is substantially uniform, and thus the distribution of brightness on the liquid crystal panel is also substantially uniform.

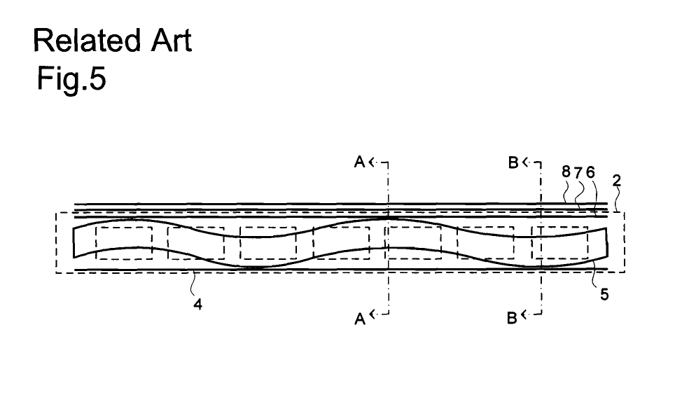

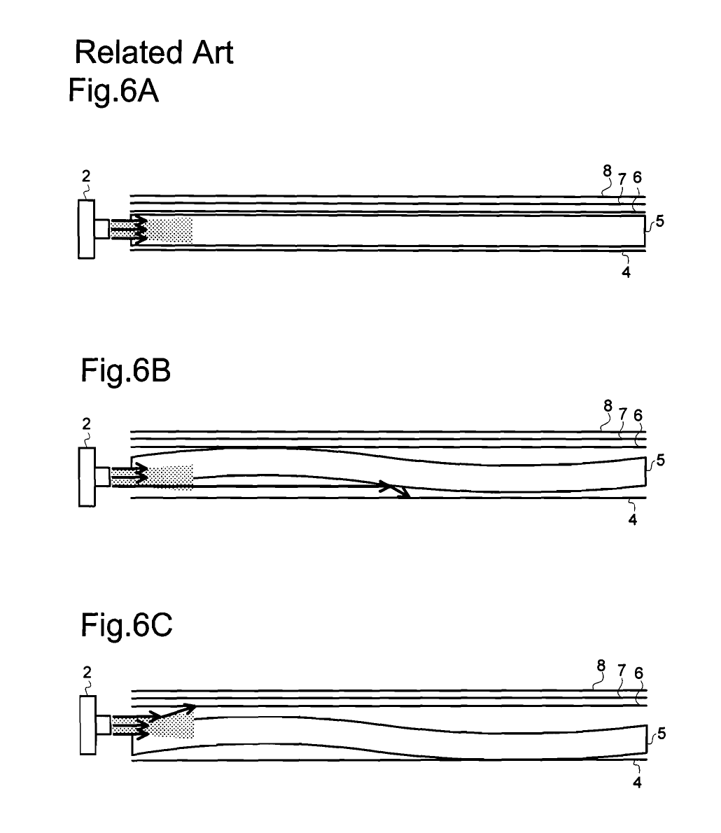

In the backlight according to the first embodiment of the present invention as well, heat from the LED light sources 2 causes the light guide plate 5 to warp. FIG. 5, which has already been referred to above, is a diagram showing, as seen from above, the backlight according to the first embodiment in a condition in which the light guide plate 5 is warped. A schematic side sectional view taken along line A-A of FIG. 5 is shown in FIG. 2B, and a schematic side sectional view taken along line B-B of FIG. 5 is shown in FIG. 2C.

As shown in FIG. 2B and FIG. 2C, if the light guide plate 5 warps, the guide members 9a, 9b stretch or contract to be deformed along with the warping of the light guide plate 5. And, a portion of light emitted from the LED light source 2 enters the light guide plate 5 through a side surface thereof after being diffusely reflected by the guide member 9a or 9b. In this way, even in a case in which the light guide plate 5 is warped, it is possible to correctly direct the light emitted from the LED light source 2 into the light guide plate 5, and thereby to reduce unevenness in the emission brightness of the backlight. Thus, this backlight reduces the occurrence of uneven brightness on a liquid crystal panel (not shown) which it illuminates, and as a result, it is possible to reduce degradation of display quality of a liquid crystal display.

### Second Embodiment

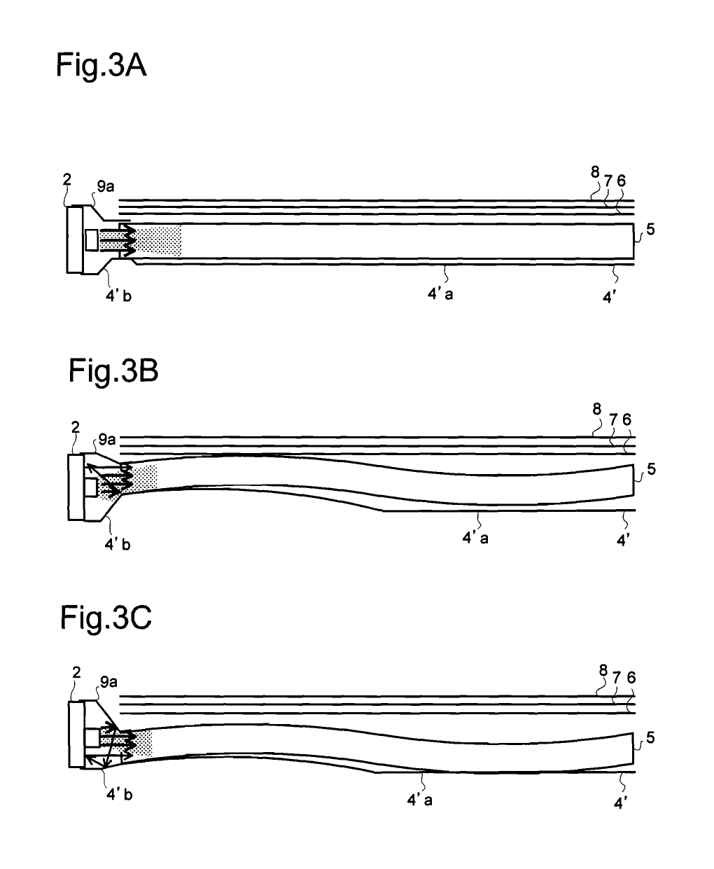

Next, a second embodiment of the present invention will be described. FIG. 3A is a schematic side sectional view showing a backlight according to the second embodiment of the present invention in a normal condition in which a light guide plate 5 is not warped (note that FIG. 3A, and later-referred-to FIGS. 3B and 3C only show an upper LED light source 2 disposed at the upper side, and a lower LED light source 2 disposed at the lower side is not shown). The backlight according to the second embodiment is an example obtained by adopting a reflection sheet 4′ instead of the reflection sheet 4 in the above-described backlight according to the first embodiment.

The reflection sheet 4′ is a piece of reflection sheet which has a body part 4′a as a part covering a back surface of the light guide plate 5 and a guide part 4b′ extending from the body part 4′a toward the LED light source 2. The reflection sheet 4′ is generally formed thinner than typical reflection sheets used in backlights, and the guide part 4′b is formed as an elastic part. Incidentally, the reflection sheet 4′ may be formed such that the body part 4′a is as thick as the typical reflection sheets used in backlights and the guide part 4′b is thinner than the body part 4′a.

An end part of the guide part 4′b along a border between the guide part 4′b and the body part 4′a is bonded to a back surface of a light entrance part of the light guide plate 5. Furthermore, another end part of the guide part 4′b is bonded to a back-facing side surface of a substrate of the LED light source 2. This configuration of the upper LED light source 2 is also adopted in the lower LED light source 2, which is not shown in FIG. 3A (thus, FIG. 3A shows the configuration of the right edge of the reflection sheet 4′ only in a simplified manner).

In the backlight according to the second embodiment of the present invention as well, heat from the LED light sources 2 causes the light guide plate 5 to warp. A diagram which shows, as seen from above, the backlight according to the second embodiment in a condition in which the light guide plate 5 is warped will be obtained by replacing the reflection sheet 4 with the reflection sheet 4′ in FIG. 5, which has already been referred to above. A schematic side sectional view taken along line A-A of the thereby obtained diagram is shown in FIG. 3B, and one taken along line B-B of the same diagram is shown in FIG. 3C.

As shown in FIG. 3B and FIG. 3C, if the light guide plate 5 warps, the guide member 9a and the guide part 4′b stretch or contract to be deformed along with the warping of the light guide plate 5. And, a portion of light emitted from the LED light source 2 enters the light guide plate 5 through a side surface thereof after being diffusely reflected by the guide member 9a or being reflected by the guide part 4′b. In this way, even in a case where the light guide plate 5 is warped, it is possible to correctly direct the light emitted from the LED light source 2 into the light guide plate 5, and thereby to reduce unevenness in the emission brightness of the backlight. Thus, this backlight reduces the occurrence of uneven brightness on a liquid crystal panel (not shown) which it illuminates, and as a result, it is possible to reduce degradation of display quality of a liquid crystal display.

Further, with the second embodiment, in which light from the LED light source 2 is directed into the light guide plate 5 by using the guide part 4′b which is a part of the reflection sheet 4′, it is possible to reduce the number of components.

Multiple variations and modifications can be made in the embodiments described herein, without departing from the spirit and scope of the invention.

For example, the guide members 9a, 9b may be formed as reflection sheets which merely reflect light without diffusion.

Furthermore, the present invention is applicable, for example, to a backlight in which a light source is arranged merely at one of upper and lower side surfaces of a light guide plate, or to a backlight in which a light source is arranged at least at one of right and left side surfaces of a light guide plate.

Moreover, the display which is provided with the backlight according to the present invention is not limited to a liquid crystal display, but, for example, may be a display such as an advertisement display device in which advertisement pictures (display section) are illuminated by a backlight from behind.

What is claimed is:

1. A backlight, comprising:
a light guide plate;
a light source having a plurality of light emitting elements which are arranged to face a side surface of the light guide plate; and
an elastic guide part which extends in a direction along which the light emitting elements are arranged, which is joined to the light source and to a light entrance part of the light guide plate through which light from the light source enters the light guide plate, and which reflects light emitted from the light source to direct the light to a side surface of the light guide plate.

2. The backlight of claim 1, wherein the guide part is a sheet which diffusely reflects light.

3. The backlight of claim 1, wherein the guide part is a part of a reflection sheet which reflects light taken out from a back surface of the light guide plate.

4. A display, comprising:
a backlight including:
a light guide plate;
a light source having a plurality of light emitting elements which are arranged to face a side surface of the light guide plate; and
an elastic guide part which extends in a direction along which the light emitting elements are arranged, which is joined to the light source and to a light entrance part of the light guide plate through which light from the light source enters the light guide plate, and which reflects light emitted from the light source to direct the light to a side surface of the light guide plate; and
a display section which is illuminated by the backlight.
